(19) United States
(12) Patent Application Publication
(10) Pub. No.: US 2009/0303984 A1
(43) Pub. Date: Dec. 10, 2009

(54) System and method for private conversation in a public space of a virtual world

(76) Inventors: Jason T. Clark, Raleigh, NC (US); Ami H. Dewar, Durham, NC (US); Robert C. Leah, Cary, NC (US); Nicholas E. Poore, Durham, NC (US); Peter C. Yim, Raleigh, NC (US)

Correspondence Address: HOLMAN IP LAW/IBM RSW, 175 S Main Street, Suite #850, Salt Lake City, UT, 84111, US

(21) Appl. No.: 12/135,336

(22) Filed: Jun. 9, 2008

(51) Int. Cl. H04L 12/66

(52) U.S. Cl. 370/352

(57) ABSTRACT

A system and method for allowing a first user and a second user to converse privately in a public place in a metaverse application. The metaverse system includes a metaverse server and a privacy engine. The metaverse server executes a metaverse application. The metaverse application includes a metaverse virtual world that enables a first user to interact with a second user in a public place of the metaverse virtual world. The privacy engine is coupled to the metaverse server. The privacy engine recognizes a private conversation trigger and creates a virtual private space in the public place of the metaverse virtual world in response to the private conversation trigger. The virtual private space facilitates a private audio conversation between the first user and the second user within the public place of the metaverse virtual world.

### BACKGROUND

The term metaverse is widely used to describe a fully immersive 3D virtual space, a virtual environment where humans are represented by an avatar and may interact with other user's avatars, both socially and economically, and with software agents in a cyber space. The environment in a metaverse is built upon a metaphor of the real world, but in some cases, without the physical limitations of the real world. In a metaverse application, such as Second Life®, users are allowed to have friends, create groups, and talk and mingle with strangers, fly, and teleport to different locations, and between different metaverses.

Currently, a user in a metaverse is able to communicate with other users in the metaverse in real-time by entering text or through the use of a microphone connected to the user's computer. In the case of using a microphone, the user speaks into the microphone, and the user's computer converts the audio input from the user to a digitally sampled version. The digital version of the audio is then relayed from the user's computer to one or more other users' computers over the internet using a protocol such as Voice over Internet Protocol (VoIP).

Currently, conversations in a virtual world or metaverse such as Second Life® are public conversations and are typically audible to anyone in the same general vicinity of the metaverse world. In the virtual world, metaverse sounds broadcast in a concentric circle away from the source. Because of the simulated propagation of sound waves in the virtual world, people in a public place can hear everybody else if they are close enough to each other. A user who is farther away might not be able to hear another user's audible communication and/or to discern what the other user is saying. However, users within a general vicinity of a speaker can listen to the speaker's conversations and/or participate in the speaker's conversations. While a user may whisper into the microphone to mimic a whisper in the virtual world, even whispering in a microphone does not prevent the simulation of sound waves from potentially reaching unintended recipients in a virtual world. Thus, currently in a virtual world or metaverse two or more users are not able to hold a private conversation in a public place.

### SUMMARY

Embodiments of a system are described. In one embodiment, the system is a system for allowing a first user and a second user to converse privately in a public place in a metaverse application. The metaverse system includes a metaverse server and a privacy engine. The metaverse server executes a metaverse application. The metaverse application includes a metaverse virtual world that enables a first user to interact with a second user in a public place of the metaverse virtual world. The privacy engine is coupled to the metaverse server. The privacy engine recognizes a private conversation trigger and creates a virtual private space in the public place of the metaverse virtual world in response to the private conversation trigger. The virtual private space facilitates a private audio conversation between the first user and the second user within the public place of the metaverse virtual world. Additionally, the privacy engine, in some embodiments, is further configured to create the virtual private space when an avatar of the first user aligns face-to-face with an avatar of the second user within a specified proximity in relation to one another. Other embodiments of the system are also described.

Further embodiments of the system include a visual modifier, an audio modifier, and a privacy configurator. The visual modifier displays a private conversation border around the virtual private space. The private conversation border approximately defines an area of the virtual private space. In some embodiments, the visual modifier is further configured to display private conversation indicators relative to the first and second users of the private audio conversation. The private conversation indicators indicate to users outside of the private audio conversation that the first and second users are participants of the private audio conversation. The audio modifier initiates a first sound profile for any sound that originates within the virtual private space. The audio modifier also initiates a second sound profile for any sound that originates outside of the virtual private space. The first sound profile defines a higher volume than the second sound profile. The privacy configurator implements a privacy configuration interface and allows the first user to configure privacy settings associated with the private audio conversation.

Additionally, some embodiments of the system include a memory device and a participation controller. The memory device stores the privacy settings and instructions associated with the privacy engine. The participation controller enables the first user to send an invitation to another user to join the private audio conversation. The participation controller is further configured to enable a third user to send a request to the first user to allow the third user to join the private audio conversation.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

FIG. 1 depicts a schematic diagram of one embodiment of a computer network system.

FIG. 2 depicts a schematic block diagram of one embodiment of a client computer of the computer network system of FIG. 1.

FIG. 3 depicts a schematic diagram of one embodiment of a metaverse server with a privacy engine for use in association with the privacy configuration interface of FIG. 2.

FIG. 4 depicts a schematic diagram of one embodiment of a metaverse client viewer for use with the privacy engine of FIG. 3.

FIG. 5 depicts a schematic diagram of one embodiment of a privacy configuration interface.

FIG. 6A depict schematic diagrams of one embodiment of a private conversation invitation interface for use with the metaverse client viewer of FIG. 2.

FIG. 6B depicts one embodiment of a private conversation request interface for use with the metaverse client viewer of FIG. 2.

FIG. 7 depicts a schematic flow chart diagram of one embodiment of an auto-initiated private conversation method for use with the privacy engine of FIG. 3.

FIG. 8 depicts a schematic flow chart diagram of one embodiment of a private conversation invitation method for use with the privacy engine of FIG. 3.

FIG. 9 depicts a schematic flow chart diagram of one embodiment of a private conversation request method for use with the privacy engine of FIG. 3.

Throughout the description, similar reference numbers may be used to identify similar elements.

### DETAILED DESCRIPTION

In the following description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

While many embodiments are described herein, at least some of the described embodiments facilitate a metaverse server to execute a metaverse application in which a first user and a second user are allowed to hold a private conversation in a public place of a metaverse virtual world. An exemplary metaverse server includes a server for Second Life®. This and other metaverse servers serve a virtual world simulation, or metaverse, through a software application that may be stored and executed on a computer system. Additionally, some embodiments facilitate configuring privacy settings. Additionally, some embodiments facilitate storing privacy settings.

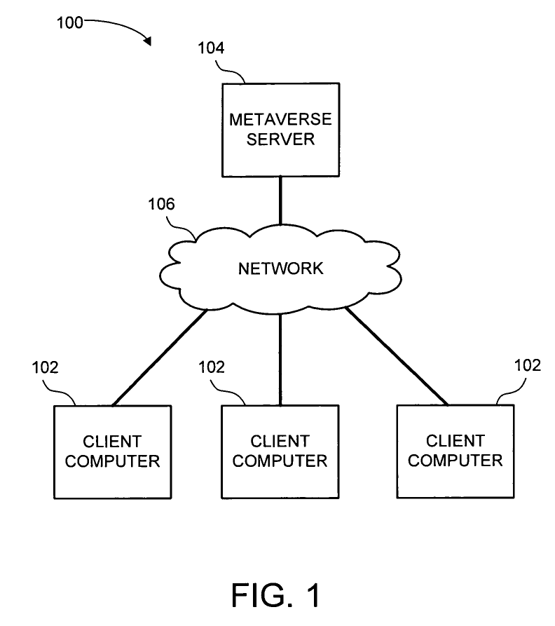

FIG. 1 depicts a schematic diagram of one embodiment of a computer network system 100. The computer network system 100 may interface a system user and a metaverse server 104 according to the interface operations of a client computer 102. The illustrated computer network system 100 includes a client computer 102, a metaverse server 104, and a network 106. Although the depicted computer network system 100 is shown and described herein with certain components and functionality, other embodiments of the computer network system 100 may be implemented with fewer or more components or with less or more functionality. For example, some embodiments of the computer network system 100 include a plurality of metaverse servers 104 and a plurality of networks 106. Additionally, some embodiments of the computer network system 100 include similar components arranged in another manner to provide similar functionality, in one or more aspects.

The client computer 102 manages the interface between the system user and the metaverse server 104. In one embodiment, the client computer 102 is a desktop or laptop computer. In other embodiments, the client computer 102 is a mobile computing device that allows a user to connect to and interact with a metaverse. In some embodiments, the client computer 102 is a video game console. The client computer 102 is connected to the metaverse server 104 via a local area network (LAN) or other type of network 106.

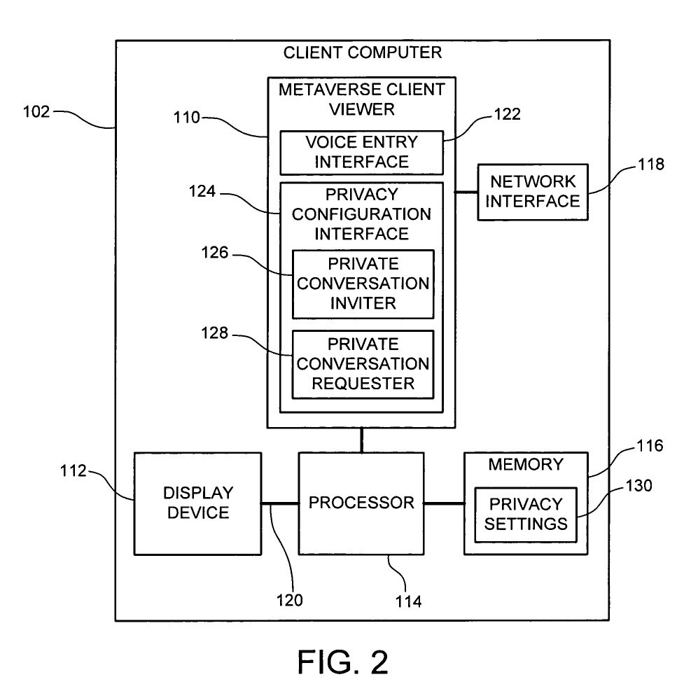

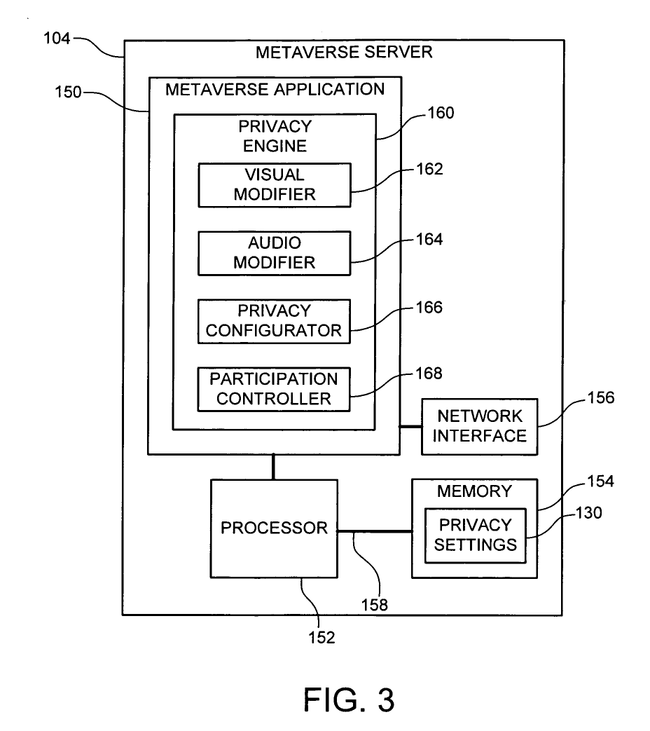

The metaverse server 104 hosts a simulated virtual world, the metaverse, to a plurality of client computer 102. In one embodiment, the metaverse server 104 is an array of servers. In some embodiments, a specified area of the metaverse is simulated by a single server instance, and multiple server instances may be run on a single metaverse server 104. In some embodiments, the metaverse server 104 includes a plurality of simulation servers dedicated to physics simulation in order to manage interactions and handle collisions between characters and objects in a metaverse. In some embodiments, the metaverse server 104 includes a plurality of storage servers dedicated to storing data related to objects and characters in the metaverse world. The data stored on the plurality of storage servers may include object shapes, avatar shapes and appearances, audio clips, metaverse related scripts, and other metaverse related objects. The plurality of storage servers may also store data associated with privacy settings and configuration options as described in greater detail below in relation to FIGS. 2 and 3.

The network 106 may communicate traditional block I/O such as over a storage area network (SAN). The network 106 may also communicate file I/O such as over a transmission control protocol/internet protocol (TCP/IP) network or other similar communication protocols. In some embodiments, the computer network system 100 includes two or more networks 106. In some embodiments, the client computer 102 may be connected directly to a metaverse server 104 via a backplane or system bus. In one embodiment, the network 106 may include a cellular network, another type of network, or a combination of networks.

FIG. 2 depicts a schematic block diagram of one embodiment of a client computer 102 of the computer network system 100 of FIG. 1. The illustrated client computer 102 includes a metaverse client viewer 110, a display device 112, a processor 114, a memory device 116, a network interface 118, and one or more bus interfaces 120. In one embodiment, the bus interfaces 120 facilitate communications related to software associated with the metaverse client viewer 110 executing on the client computer 102, including processing metaverse application commands, as well as storing, sending, and receiving data packets associated with the application software of the metaverse. Although the depicted client computer 102 is shown and described herein with certain components and functionality, other embodiments of the client computer 102 may be implemented with fewer or more components or with less or more functionality.

In one embodiment the client computer 102 of FIG. 2 implements the metaverse client viewer 110 coupled to a metaverse server 104 attached to the network 106 of FIG. 1. In some embodiments, the metaverse client viewer 110 is stored in the memory device 116 or a data storage device within the client computer 102. In some embodiments, the metaverse client viewer 110 includes processes and functions which are executed on the processor 114 within the client computer 102.

In one embodiment, the metaverse client viewer 110 is a client program executed on the client computer 102. In some embodiments, the metaverse client viewer 110 enables a user on a client computer 102 to connect to a metaverse server 104 over a network 106. The metaverse client viewer 110 is further configured to enable a user on the client computer 102 to interact with other users on other client computers 102 that are also connected to the metaverse server 104. The depicted metaverse client viewer 110 includes a voice interface 122 such as a microphone to allow a first user to verbally speak to other users in the metaverse virtual world and a privacy configuration interface 124.

As depicted, the privacy configuration interface 124 includes a private conversation inviter 126 and a private conversation requester 128. The privacy configuration interface 124 facilitates a user to configure privacy options and user preferences in relation to holding a private conversation in a public place of the metaverse virtual world. In particular, the functions of the metaverse client viewer 110 allow a user to converse privately in a public place in a metaverse virtual world. The private conversation inviter 126 allows a user in a private conversation to invite another user in the metaverse virtual world to join the private conversation. The private conversation requester 128 allows a user outside of a private conversation to request another user presently in a private conversation to join the private conversation. Embodiments of the process of conversing privately in a public place in a metaverse virtual world and inviting other users to join private conversations are described in further detail below in relation to FIG. 3.

In some embodiments, the display device 112 is a graphical display such as a cathode ray tube (CRT) monitor, a liquid crystal display (LCD) monitor, or another type of display device. In one embodiment, the display device 112 is configured to convey a visual representation of a metaverse virtual world, as well as control and configuration tools to control and configure aspects of the metaverse client viewer 110 as well as the processes related to conversing privately in a public place in a metaverse virtual world.

In one embodiment, the processor 114 is a central processing unit (CPU) with one or more processing cores. In other embodiments, the processor 114 is a graphical processing unit (GPU) or another type of processing device such as a general purpose processor, an application specific processor, a multi-core processor, or a microprocessor. Alternatively, a separate GPU may be coupled to the display device 112. In general, the processor 114 executes one or more instructions to provide operational functionality to the client computer 102. The instructions may be stored locally in the processor 114 or in the memory device 116. Alternatively, the instructions may be distributed across one or more devices such as the processor 114, the memory device 116, or another data storage device.

The illustrated memory device 116 includes privacy settings 130. In some embodiments, the privacy settings 130 are used in conjunction with the related functions and operations of conversing privately in a public place in a metaverse virtual world. In some embodiments, a user configures settings associated with conversing privately in a public place in a metaverse virtual world. The configuration settings the user selects may then be stored in the memory device 116 as the privacy settings 130. Embodiments of the process of conversing privately in a public place in a metaverse virtual world are described in further detail below in relation to FIG. 3. In some embodiments, the memory device 116 is a random access memory (RAM) or another type of dynamic storage device. In other embodiments, the memory device 116 is a read-only memory (ROM) or another type of static storage device. In other embodiments, the illustrated memory device 116 is representative of both RAM and static storage memory within a single computer network system 100. In other embodiments, the memory device 116 is an electronically programmable read-only memory (EPROM) or another type of storage device. Additionally, some embodiments store the instructions related to the operational functionality of the client computer 102 as firmware such as embedded foundation code, basic input/output system (BIOS) code, or other similar code.

The network interface 118, in one embodiment, facilitates initial connections between the client computer 102 and the metaverse server 104 in response to a user on the client computer 102 requesting to login to the metaverse server 104 and to maintain a connection established between the client computer 102 and the metaverse server 104. In some embodiments, the network interface 118 handles communications and commands, on the client side, between the client computer 102 and the metaverse server 104. The communications and commands are exchanged over the network 106.

In one embodiment, the client computer 102, the display device 112, the processor 114, the memory device 116, the network interface 118, and other components within the computer network system 100 may be coupled to one or more bus interfaces 120. The bus interfaces 120 may be configured for simplex or duplex communications of data, address, and/or control information.

FIG. 3 depicts a schematic diagram of one embodiment of a metaverse server 104 with a privacy engine 160 for use in association with the privacy configuration interface 124 of FIG. 2. The illustrated metaverse server 104 includes a metaverse application 150, a processor 152, an memory device 154, a network interface 156, and one or more bus interfaces 158 to facilitate communications related to a metaverse application 150 executing on the metaverse server 104, including processing metaverse application commands, as well as storing, sending, and receiving data packets associated with the metaverse application 150. It should be noted that the configurations of the metaverse server 104 are not limited to particular hardware or software implementations. For example, at least some of the functionality of the server may occur on the client computer 102, and vice versa. Although the depicted metaverse server 104 is shown and described herein with certain components and functionality, other embodiments of the metaverse server 104 may be implemented with fewer or more components or with less or more functionality. In some embodiments, the metaverse server 104 of FIG. 3 implements the metaverse application 150 in conjunction with the metaverse client viewer 110 of the client computer 102. In some embodiments, the metaverse application 150 includes processes and functions which are stored on the memory device 154 and executed on the processor 152. In some embodiments, the metaverse application 150 may be executed on a metaverse server installed on the client computer 102.

The illustrated metaverse server 104 of FIG. 3 includes some of the same or similar components as the client computer 102 of FIG. 2. These components are configured to operate in substantially the same manner described above, except as noted below.

The depicted metaverse application 150 includes a privacy engine 160. In one embodiment, the metaverse application 150 simulates a fully immersive three-dimensional virtual space, or metaverse, that a user on a client computer 102 may enter as an avatar and interact with other avatars and objects in the metaverse via the metaverse client viewer 110. Thus, a plurality of users, each on their own client computer 102, may interact and communicate with each other within the metaverse.

The depicted privacy engine 160 includes a visual modifier 162, an audio modifier 164, a privacy configurator 166, and a participation controller 168. The privacy engine 160 allows a user to converse privately with other users in the metaverse virtual world generated by the metaverse application 150. In some embodiments, the privacy engine 160 generates a virtual sound tunnel around a number of users in the metaverse virtual world. In some embodiments, the privacy engine 160 generates the virtual sound tunnel as a privacy sphere or otherwise some private space around a certain number of users in the metaverse world. The private space envelopes the users in a virtual sound proof area in which only the users in the private space are enabled to hear the conversations of one another. The private space may be generated in a public place of the metaverse virtual world. Thus, the private space allows users to communicate privately with one another in a public place of the metaverse virtual world. In some embodiments, there are two or more users in the private space. Alternatively, a single user may generate a private space and may be the only user in the private space. In some embodiments, a user initiates a private space and then invites another user to enter the private space via the private conversation inviter 126.

In one embodiment, a first user at a first location communicates with a second user at a second location privately on a virtual wireless radio within the metaverse. More specifically, in some embodiments, a first private space with one or more first users located in a first geographical location of the metaverse is linked to a second private space with one or more second users located in a second geographical location of the metaverse. In some embodiments, the first and second private spaces are located in two different metaverse virtual worlds. Thus, the first users in the first private space are enabled to communicate privately with the second users in the second private space similar to a virtual wireless radio such as a private channel on a family radio service (FRS) radio within a metaverse virtual world.

In one embodiment, the visual modifier 162 fades the visual background of the metaverse virtual world outside of the private space from the perspective of a user inside the private space. In some embodiments, the visual modifier 162 colors the background and surrounding area of the private space black and white or otherwise gives the background and surrounding area a grayscale coloring while maintaining the full color spectrum of the area inside the private space. In some embodiments, the visual modifier 162 fades and/or dims the brightness level of the surrounding area outside of the private space while maintaining the default brightness level of the area inside the private space. Otherwise, to a user outside of a private space, there is no effect on the default visual and graphic levels of their respective virtual surroundings of the metaverse virtual world. In some embodiments, the visual modifier 162 adds a private conversation indicator (PCI) relative to a user that is presently in a private conversation. The PCI may indicate to other users outside of the private conversation that the user is presently in a private conversation.

In one embodiment, the audio modifier 164 diminishes sounds that originate outside of the private space while maintaining the default sound and aural aspects of the metaverse virtual world inside the private space from the perspective of a user that is inside the private space. In some embodiments, the visual modifier 162 adds a notification flag to the users in a private space. A notification flag above the head of a user's avatar notifies other users outside of the private space that the user in the private space is currently part of a private conversation. The notification flag may be a bar above the head of the user's avatar with the word “private” written in the bar. In some embodiments, the notification flag may be viewable by fellow users inside a private space as well as users outside of the private space. Thus, the notification flag notifies users outside of the private space that users inside of the private space or otherwise participating in a private conversation may not be able to hear what the users outside of the private space are saying. The notification flag cues users outside of a private conversation that what they are saying to users in a private conversation may not be perceivable to the users in the private space.

In one embodiment, the privacy configurator 166 allows a user on a client computer 102 to configure the privacy settings associated with starting and participating in a private conversation and to store the privacy settings 130 in a memory device 126 on a user's client computer 102. In some embodiments, a user interfaces with the privacy configurator 166 via the privacy configuration interface 124. In some embodiments, the privacy settings 130 are stored on the memory device 154 of the metaverse server 104. Additionally, in some embodiments, the memory device 154 stores the privacy settings 130 for two or more users of the metaverse virtual world.

The participation controller 168 allows a user in a private conversation to invite another user in the metaverse virtual world to join the private conversation. The participation controller 168 also allows a user outside of a private conversation to request another user presently in a private conversation to join the private conversation. In one embodiment, the participation controller 168 allows the user to invite another user to join the private conversation in conjunction with the private conversation inviter 126. Additionally, in some embodiments, the participation controller 168 allows the user outside of the proper conversation to request to join the proper conversation in conjunction with the private conversation requester 128.

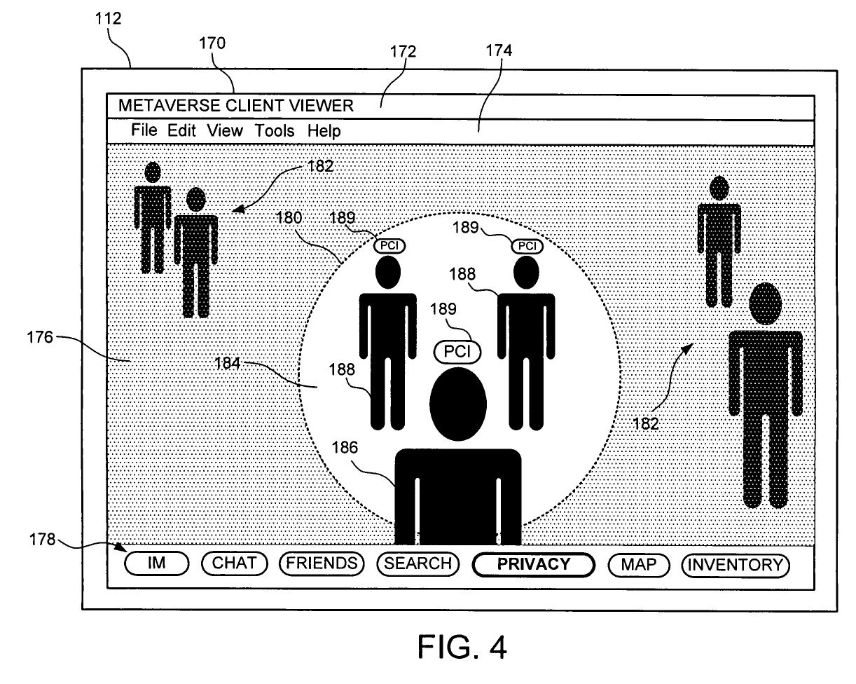

FIG. 4 depicts a schematic diagram of one embodiment of a metaverse client viewer 170 for use with the privacy engine 160 of FIG. 3. In particular, the metaverse client viewer 170 shows the private space 184 of a private conversation within a graphical user interface (GUI) for display on a display device 112. It should be noted that other embodiments of the private space 184 may be integrated with existing or new interfaces that are used to display related information.

The illustrated metaverse client viewer 170 includes a title bar 172 to show a title of the metaverse client viewer 170, a menu bar 174 to show possible menu selections within the metaverse client viewer 170, a surrounding viewing space 176 to show a metaverse within the metaverse client viewer 170, a group of metaverse client viewer control buttons 178, including a Privacy button. Additionally, the illustrated metaverse client viewer 170 also depicts a private space border 180, outside users 182 that are users outside of the private space border 180, and a private space 184. Additionally, the illustrated metaverse client viewer 170 also includes a first user 186 within the private space 184, other users 188 also within the private space 184, and PCIs 189. In one embodiment, the first user 186 participates in a private conversation with the other users 188 within the private space 184. As illustrated in FIG. 4, the surrounding viewing space 176 and the outside users 182 are faded by the visual modifier 162 from the perspective of the first user 186. Simultaneously, the visual modifier 162 maintains the default visual and graphic settings of the metaverse virtual world inside the private space border 180 from the perspective of the first user 186. The perspective of the first user 186 is merely the point of view of a user at the first user's 186 client computer 102 and would be substantially similar to the point of view of the other users 188 at their respective client computers 102. Additionally, from the point of view of the outside users 182, the default visual and graphic settings of the metaverse virtual world remains unchanged. In some embodiments, the visual modifier 162 adds a PCI 189 relative to the first user 186 and the other users 188 that are presently in a private conversation. The PCI 189 indicates to the users 182 outside of the private conversation that the first user 186 and the other users 188 are presently engaged in a private conversation. The PCI 189 may be associated with a name title bar that floats above the head of a user's avatar in the metaverse virtual world and indicates the name of the avatar. For example, when the first user 186 is in a private conversation, the name title bar may change to a different color, or may flash a different color to indicate to the other users 182 that the first user 186 is presently in a private conversation.

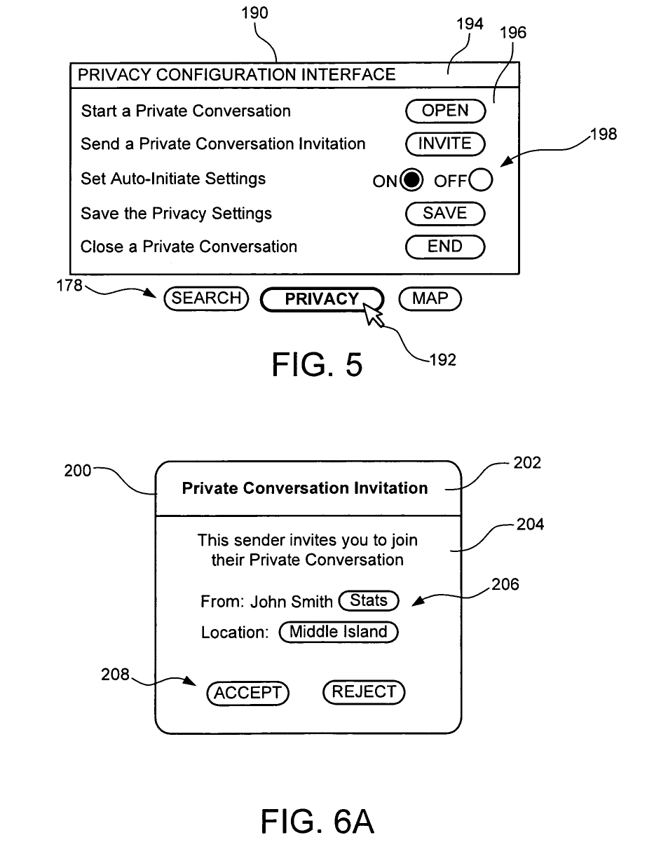

FIG. 5 depicts a schematic diagram of one embodiment of a privacy configuration interface 190 for use with the privacy configurator 166 of FIG. 3. In association with the privacy configuration interface 190, FIG. 5 also depicts a cursor 192 clicking on the Privacy control button among a representative group of the group of metaverse client viewer control buttons 178 depicted in FIG. 4. In one embodiment, the privacy configuration interface 190 is accessed via the illustrated Privacy control button of the metaverse client viewer 170 of FIG. 4. In some embodiments, a user clicks on the Privacy control button via the cursor 192 to open the privacy configuration interface 190.

The illustrated privacy configuration interface 190 includes a title bar 194 to show a title of the privacy configuration interface 190, a group link configuration viewing space 196 to show privacy configuration options, and a group of privacy configuration control buttons 198, which may include a drop down menu, a checkbox, a radio button, a single-click button, among other possible privacy configuration control buttons 198. In some embodiments, the privacy configuration control buttons 198 include an option to automatically initiate private conversations. In some embodiments, the privacy control buttons 198 include options to start a private conversation, send an invitation to join a private conversation, save the privacy settings, and to end a private conversation. Other embodiments may include fewer or more privacy configuration options and functions. In some embodiments, the privacy settings are stored in the memory device 116 and/or 154.

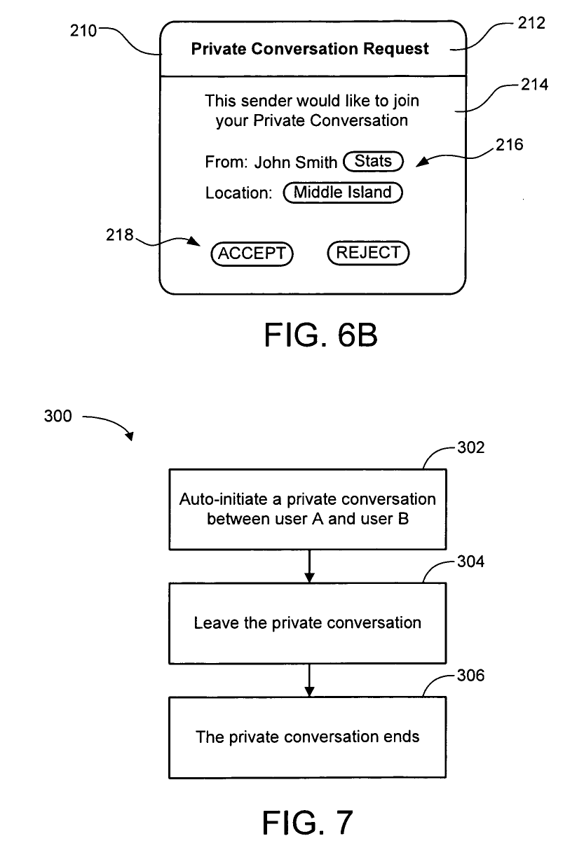

FIG. 6A depict schematic diagrams of one embodiment of a private conversation invitation interface 200 for use with the metaverse client viewer 110 of FIG. 2. In particular, the private conversation invitation interface 200 shows the details generated by the privacy configuration interface 190 within a graphical user interface (GUI) for display on a display device 112, in order to invite a user to join a private conversation. It should be noted that other embodiments of the private conversation invitation interface 200 may be integrated with existing or new interfaces that are used to display related information.

The illustrated private conversation invitation interface 200 includes a title bar 202 to show a title of the private conversation invitation interface 200, a private conversation invitation message body 204 to show the details of the private conversation invitation, such as name and location details 206 of the user that sent the private conversation invitation, as well as private conversation invitation control buttons 208. The user that receives the private conversation invitation can click an Accept button to accept the invitation and join the private conversation, or can click on a Reject button to reject the invitation and not join the private conversation. The name and location details 206 may also include control buttons in order to review more information about the user that sent the private conversation invitation, as well as a button to view a map of where the user that sent the private conversation invitation currently is, or even a live view of the user that sent the private conversation invitation.

FIG. 6B depicts one embodiment of a private conversation request interface for use with the metaverse client viewer of FIG. 2. In particular, the private conversation request interface 210 show the details generated by the privacy configuration interface 190 within a graphical user interface (GUI) for display on a display device 112, in order to request to join an existing private conversation. It should be noted that other embodiments of the private conversation request interface 210 may be integrated with existing or new interfaces that are used to display related information.

The illustrated private conversation request interface 210 includes a title bar 212 to show a title of the private conversation request interface 210, a private conversation request message body 214 to show the details of the private conversation invitation, such as name and location details 216 of the user that sent the private conversation request, as well as private conversation request control buttons 218. From the request control buttons 218, a user that receives the private conversation request can click an Accept button to accept the request to join the private conversation, or can click on a Reject button to reject the request to join the private conversation. The name and location details 216 may also include control buttons in order to review more information about the user that sent the private conversation request, as well as a button to view a map of where the user that sent the private conversation request currently is, or even a live view of the user that sent the private conversation request.

FIG. 7 depicts a schematic flow chart diagram of one embodiment of an auto-initiated private conversation method 300 for use with the privacy engine 160 of FIG. 3. For ease of explanation, the auto-initiated private conversation method 300 is described with reference to the privacy engine 160 of FIG. 3. However, some embodiments of the auto-initiated private conversation method 300 may be implemented with other privacy engines. Additionally, the auto-initiated private conversation method 300 is described in conjunction with the metaverse client viewer 110 of FIG. 2, but some embodiments of the auto-initiated private conversation method 300 may be implemented with other metaverse client viewers.

In the illustrated auto-initiated private conversation method 300, a user in a metaverse virtual world, user A, auto-initiates 302 a private conversation with another user, user B. In some embodiments, a user may enable auto-initiated private conversations via the auto-initiate setting illustrated in the privacy configuration interface 190 of FIG. 5. In some embodiments, a private conversation between the users A and B auto-initiates 302 when the avatar of user A stands face to face opposite of user B. In other words, when the “gaze” of the avatar of user A is considerably aligned with the “gaze” of the avatar of user B, the user's A and B auto-initiate 302 a private conversation with each other. In one embodiment, the functions and operations of the auto-initiated private conversation is facilitated by the privacy engine 160 in conjunction with the metaverse client viewer 110. In some embodiments, the private conversation between user A and user B includes a private space in which user A and user B speak with each other as they would normally speak and communicate in the metaverse virtual world with the exception that other users outside of the private space cannot hear the conversation between user A and user B. Additionally, in some embodiments, the background graphics and sounds outside of the private space are faded by the visual and audio modifiers 162 and 164, respectively.

At some point in the illustrated auto-initiated private conversation method 300, the user A and/or the user B leave 304 the private conversation. In some embodiments, the private conversation then ends 306. In some embodiments, the private conversation ends when user A or user B walks away from each other.

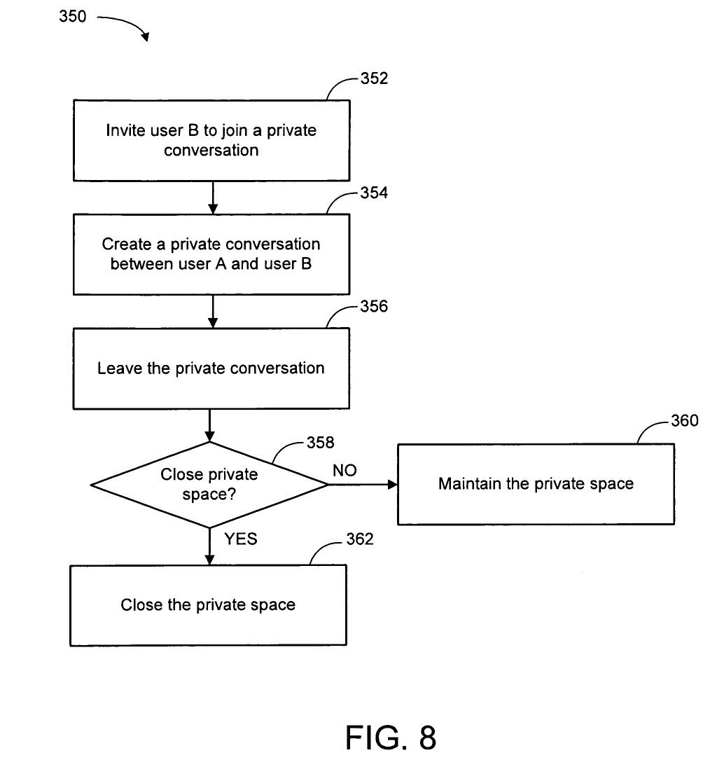

FIG. 8 depicts a schematic flow chart diagram of one embodiment of a private conversation invitation method 350 for use with the privacy engine 160 of FIG. 3. For ease of explanation, the private conversation invitation method 350 is described with reference to the privacy engine 160 of FIG. 3. However, some embodiments of the private conversation invitation method 350 may be implemented with other privacy engines. Additionally, the private conversation invitation method 350 is described in conjunction with the metaverse client viewer 110 of FIG. 2, but some embodiments of the private conversation invitation method 350 may be implemented with other metaverse client viewers.

In the illustrated private conversation invitation method 350, a user in a metaverse virtual world, user A, invites 352 another user, user B, to join a private conversation. In response to user B joining the private conversation, the privacy engine 160 creates 354 a private space around the user A and the user B. The private space allows the users A and B to converse privately without users outside of the private space being able to hear what they may be saying to one another. In some embodiments, the user A sends a private conversation invitation 200 to user B via the privacy configuration interface 190.

In one embodiment, the user A and/or the user B leave 356 the private conversation. In some embodiments, the privacy engine 160 determines 358 whether to close the private space. In some embodiments, the privacy engine 160 prompts the user A whether to close the private space. In response to the user A choosing to keep the private space open, the privacy engine maintains 360 the private space around user A. Otherwise, the privacy engine 160 closes 362 the private space. In some embodiments, the privacy engine 160 maintains the private space as users A and B walk around the metaverse virtual world. In some embodiments, the privacy engine 160 maintains the private space automatically when one or more users leave the private conversation while two or more users still remain in the privacy conversation.

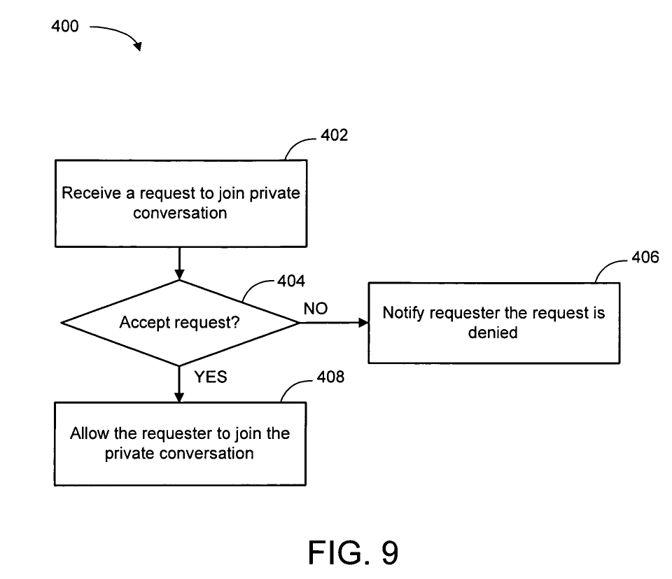

FIG. 9 depicts a schematic flow chart diagram of one embodiment of a private conversation request method 400 for use with the privacy engine 160 of FIG. 3. For ease of explanation, the private conversation request method 400 is described with reference to the privacy engine 160 of FIG. 3. However, some embodiments of the private conversation request method 400 may be implemented with other privacy engines. Additionally, the private conversation request method 400 is described in conjunction with the metaverse client viewer 110 of FIG. 2, but some embodiments of the private conversation request method 400 may be implemented with other metaverse client viewers.

In the illustrated private conversation request method 400, a user in a private conversation, user A, receives 402 a request from a requester, user B, wanting to join private conversation. The user A then determines 404 whether to allow the user B to join the private conversation. When the user A declines the request to allow the user B to join the private conversation, the privacy engine 160 notifies 406 the user B that the request is denied. Otherwise, the user B is allowed to join 408 the private conversation and enter the private space of user A.

Embodiments of the auto-initiated private conversation method 300, the private conversation invitation method 350, and the private conversation request method 400 described improve the usability of the metaverse application 150, by providing a process of simulating in a metaverse virtual world the effects of a whisper in the real world. Additionally, some embodiments facilitate improving the privacy of users in a private conversation, by providing a process to configure the functions and operations of a private space. Additionally, some embodiments facilitate inviting other users to join private conversations as well as allowing other users to request joining private conversations already in progress. Thus, by providing a system and method that allows users in a metaverse virtual world to hold private conversations in public places, a users experience in the metaverse is improved and enhanced.

It should also be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to enable a first user on a first client computer to interact in a public place of a metaverse virtual world with a second user on a second client computer. The operations also include an operation to recognize a private conversation trigger. The operations also include an operation to create a virtual private space in the public place of the metaverse virtual world in response to the private conversation trigger. The virtual private space facilitates a private audio conversation between the first user and the second user within the public place of the metaverse virtual world.

Additionally, in some embodiments, the operations include an operation to create the virtual private space when an avatar of the first user aligns face-to-face with an avatar of the second user within a specified proximity in relation to one another. The operations also include an operation to display a privacy configuration interface. The privacy configuration interface allows the first user to interface with the privacy configurator. The operations also include operations to display a private conversation border around the virtual private space and PCIs relative to the first and second users that are currently in a private conversation. The private conversation border defines an area of the virtual private space and the PCIs indicate to users outside of the private conversation that the first and second users are presently in a private conversation.

Additionally, in some embodiments, the operations include an operation to visually fade a space outside of the private space from the perspective of the first and second users. The operations also include operations to initiate a first sound profile for any sound that originates within the virtual private space and initiate a second sound profile for any sound that originates outside of the virtual private space. The first sound profile defines a higher volume than the second sound profile.

Additionally, in some embodiments, the operations include an operation to send an invitation from the first user to the second user to join the private audio conversation. The operations also include an operation to send a request from another user to the first user to allow the other user to join the private audio conversation. The operations also include an operation to transmit a voice input from the first user on the first client computer over a network to the second user on the second client computer. Hence, only the first and second users hear the voice of the first user. The operations also include operations to configure a privacy setting associated with the private audio conversation and to store the privacy setting.

Embodiments of the invention can take the form of an entirely hardware embodiment, an entirely software embodiment, or an embodiment containing both hardware and software elements. In one embodiment, the invention is implemented in software, which includes but is not limited to firmware, resident software, microcode, etc.

Furthermore, embodiments of the invention can take the form of a computer program product accessible from a computer-usable or computer-readable storage medium providing program code for use by or in connection with a computer or any instruction execution system. For the purposes of this description, a computer-usable or computer readable storage medium can be any apparatus that can store the program for use by or in connection with the instruction execution system, apparatus, or device.

The computer-useable or computer-readable storage medium can be an electronic, magnetic, optical, electromagnetic, infrared, or semiconductor system (or apparatus or device), or a propagation medium. Examples of a computer-readable storage medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

An embodiment of a data processing system suitable for storing and/or executing program code includes at least one processor coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A computer program product comprising a computer useable storage medium to store a computer readable program that, when executed on a computer, causes the computer to perform operations comprising:
enable a first user on a first client computer to interact in a public place of a metaverse virtual world with a second user on a second client computer;
recognize a private conversation trigger; and
create a virtual private space in the public place of the metaverse virtual world in response to the private conversation trigger, wherein the virtual private space facilitates a private audio conversation between the first user and the second user within the public place of the metaverse virtual world.

2. The computer program product of claim 1, wherein the computer readable program, when executed on the computer, causes the computer to perform further operations to create the virtual private space when an avatar of the first user aligns face-to-face with an avatar of the second user within a specified proximity in relation to one another.

3. The computer program of claim 1, wherein the computer readable program, when executed on the computer, causes the computer to perform further operations to display a privacy configuration interface, wherein the privacy configuration interface allows the first user to configure a privacy setting associated with the private audio conversation.

4. The computer program of claim 1, wherein the computer readable program, when executed on the computer, causes the computer to perform further operations comprising:
display a private conversation border around the virtual private space, wherein the private conversation border approximately defines an area of the virtual private space; and
display private conversation indicators relative to the first and second users of the private audio conversation, wherein the private conversation indicators indicate to users outside of the private audio conversation that the first and second users are participants of the private audio conversation.

5. The computer program of claim 1, wherein the computer readable program, when executed on the computer, causes the computer to perform further operations to visually fade a space outside of the virtual private space from the perspective of the first and second users.

6. The computer program of claim 1, wherein the computer readable program, when executed on the computer, causes the computer to perform further operations comprising:
initiate a first sound profile for any sound that originates within the virtual private space; and
initiate a second sound profile for any sound that originates outside of the virtual private space, wherein the second sound profile defines a lower volume than the first sound profile.

7. The computer program product of claim 1, wherein the computer readable program, when executed on the computer, causes the computer to perform further operations to send an invitation from the first user to the second user to join the private audio conversation.

8. The computer program product of claim 1, wherein the computer readable program, when executed on the computer, causes the computer to perform further operations to send a request from a third user to the first user to allow the third user to join the private audio conversation.

9. The computer program product of claim 1, wherein the computer readable program, when executed on the computer, causes the computer to perform further operations to transmit a voice input from the first user on the first client computer over a network to the second user on the second client computer, wherein only the first and second users hear the voice input of the first user.

10. The computer program product of claim 1, wherein the computer readable program, when executed on the computer, causes the computer to perform further operations comprising:
configure a privacy setting associated with the private audio conversation; and
store the privacy setting.

11. A system comprising:
a metaverse server coupled to a network, the metaverse server to execute a metaverse application, wherein the metaverse application comprises a metaverse virtual world and enables a first user to interact with a second user in a public place of the metaverse virtual world; and
a privacy engine coupled to the metaverse server, the privacy engine to recognize a private conversation trigger and to create a virtual private space in the public place of the metaverse virtual world in response to the private conversation trigger, wherein the virtual private space facilitates a private audio conversation between the first user and the second user within the public place of the metaverse virtual world.

12. The system of claim 11, wherein the privacy engine is further configured to create the virtual private space when an avatar of the first user aligns face-to-face with an avatar of the second user within a specified proximity in relation to one another.

13. The system of claim 11, wherein the privacy engine comprises a visual modifier, the visual modifier to display a private conversation border around the virtual private space, wherein the private conversation border approximately defines an area of the virtual private space.

14. The system of claim 13, wherein the visual modifier is further configured to display private conversation indicators relative to the first and second users of the private audio conversation, wherein the private conversation indicators indicate to users outside of the private audio conversation that the first and second users are participants of the private audio conversation.

15. The system of claim 11, wherein the privacy engine comprises an audio modifier, the audio modifier to initiate a first sound profile for any sound that originates within the virtual private space and to initiate a second sound profile for any sound that originates outside of the virtual private space, wherein the first sound profile defines a higher volume than the second sound profile.

16. The system of claim 11, wherein the privacy engine further comprises a privacy configurator, the privacy configurator to implement a privacy configuration interface and to allow the first user to configure privacy settings associated with the private audio conversation.

17. The system of claim 16, further comprising a memory device coupled to the privacy engine, the memory device to store the privacy settings and to store instructions associated with the privacy engine.

18. The system of claim 10, wherein the metaverse server further comprises a participation controller, the participation controller to enable the first user to send an invitation to another user to join the private audio conversation.

19. The system of claim 18, wherein the participation controller is further configured to enable a third user to send a request to the first user to allow the third user to join the private audio conversation.

20. A method comprising:
enabling a first user on a first client computer to interact in a metaverse virtual world with a second user;
recognizing a private conversation trigger; and
creating a virtual private space in the public place of the metaverse virtual world in response to the private conversation trigger, wherein the virtual private space facilitates a private audio conversation between the first user and the second user within the public place of the metaverse virtual world.

21. The method of claim 20, further comprising creating the virtual private space when an avatar of the first user aligns face-to-face with an avatar of the second user within a specified proximity in relation to one another.

22. The method of claim 20, further comprising:
displaying a private conversation border around the virtual private space, wherein the private conversation border approximately defines an area of the virtual private space;
visually fading a space outside of the virtual private space from the perspective of the first and second users; and
displaying private conversation indicators relative to the first and second users of the private audio conversation, wherein the private conversation indicators indicate to users outside of the private audio conversation that the first and second users are participants of the private audio conversation.

23. The method of claim 20, further comprising:
initiating a first sound profile for any sound that originates within the virtual private space; and
initiating a second sound profile for any sound that originates outside of the virtual private space, wherein the second sound profile defines a lower volume than the first sound profile.

24. The method of claim 20, further comprising sending an invitation from the first user to another user to join the private audio conversation.

25. The method of claim 20, further comprising sending a request from a third user to the first user to allow the third user to join the private audio conversation.

26. A privacy apparatus comprising:
means for enabling a first user on a first client computer to interact in a metaverse virtual world with a second user;
means for recognizing a private conversation trigger; and
means for creating a virtual private space in the public place of the metaverse virtual world in response to the private conversation trigger, wherein the virtual private space facilitates a private audio conversation between the first user and the second user within the public place of the metaverse virtual world.

27. The privacy apparatus of claim 26, further comprising means for creating the virtual private space when an avatar of the first user aligns face-to-face with an avatar of the second user within a specified proximity in relation to one another.

28. The privacy apparatus of claim 26, further comprising means for displaying a private conversation border around the virtual private space, wherein the private conversation border approximately defines an area of the virtual private space.

29. The privacy apparatus of claim 26, further comprising means for visually fading a space outside of the virtual private space from the perspective of the first and second users.

30. The privacy apparatus of claim 26, further comprising means for displaying private conversation indicators relative to the first and second users of the private audio conversation, wherein the private conversation indicators indicate to users outside of the private audio conversation that the first and second users are participants of the private audio conversation.

31. The privacy apparatus of claim 26, further comprising:
means for maintaining a default sound characteristic of the metaverse virtual world for any sound that originates within the virtual private space from the perspective of the first and second users; and
means for substantially reducing any sound that originates outside of the virtual private space from the perspective of the first and second users.

32. The privacy apparatus of claim 26, further comprising means for sending an invitation from the first user to a third user to join the private audio conversation.

33. The privacy apparatus of claim 26, further comprising means for sending a request from a third user to the first user to allow the third user to join the private audio conversation.

34. The privacy apparatus of claim 26, further comprising:
means for displaying a privacy configuration interface, wherein the privacy configuration interface allows the first user to configure a privacy setting associated with the private audio conversation; and
means for storing the privacy setting.

35. A privacy method comprising:
enabling a first user to interact in a metaverse virtual world with a second user;
recognizing a private conversation trigger;
creating a virtual private space in the public place of the metaverse virtual world in response to the private conversation trigger, wherein the virtual private space facilitates a private audio conversation between the first user and the second user within the public place of the metaverse virtual world;
displaying a private conversation border around the virtual private space, wherein the private conversation border approximately defines an area of the virtual private space;
visually fading a space outside of the virtual private space from the perspective of the first and second users; and
displaying private conversation indicators relative to the first and second users of the private audio conversation, wherein the private conversation indicators indicate to users outside of the private audio conversation that the first and second users are participants of the private audio conversation;
initiating a first sound profile for any sound that originates within the virtual private space;
initiating a second sound profile for any sound that originates outside of the virtual private space, wherein the second sound profile defines a lower volume than the first sound profile.
